(19) United States
(12) Patent Application Publication
(10) Pub. No.: US 2026/0067395 A1
(43) Pub. Date: Mar. 5, 2026

(54) SYSTEM AND METHOD FOR CREATING, ORGANIZING, AND ACCESSING PURPOSE-DRIVEN SOCIAL GATHERINGS VIA A MOBILE APPLICATION

(71) Applicant: Fernando Trillo, Boerne, TX (US)

(72) Inventor: Fernando Trillo, Boerne, TX (US)

(21) Appl. No.: 19/319,645

(22) Filed: Sep. 4, 2025

Related U.S. Application Data
(60) Provisional application No. 63/690,487, filed on Sep. 4, 2024.

(51) Int. Cl. H04M 1/72436; H04M 1/72427; H04M 1/72454; H04M 1/72457

(52) U.S. Cl. CPC H04M 1/72436; H04M 1/72427; H04M 1/72454; H04M 1/72457; H04M 2201/42

(57) ABSTRACT

A mobile application that facilitates the creation and discovery of purpose-driven social gatherings, or “hotspots,” based on user interests and location. The app allows users to create and label hotspots, such as “want to meet chess players,” which appear as interactive markers on a map. Other users can explore and join these hotspots to connect with like-minded individuals. The app provides real-time updates, ensuring that users have access to the most current information about available gatherings in their area. By leveraging location-based services and user permissions, the app delivers a personalized experience, enabling users to find and attend relevant events. The app's database securely stores user profiles, hotspot details, and user interactions, while the geo-location system dynamically updates the map interface. This invention aims to foster social connections and help people with similar interests meet, create friendships, and participate in meaningful gatherings.

### CROSS-REFERENCE TO RELATED APPLICATIONS

This application claims the benefit of U.S. Provisional Application 63/690,487 filed Sep. 4, 2024, titled “SYSTEM AND METHOD FOR CREATING, ORGANIZING, AND ACCESSING PURPOSE-DRIVEN SOCIAL GATHERINGS VIA A MOBILE APPLICATION”, which is herein incorporated by reference in its entirety.

### BACKGROUND

### Field of the Art

The present invention is related to the social networking/social media field of art.

### Discussion of the State of the Art

The issue at hand is the difficulty individuals often face when trying to find others who share their specific interests or hobbies. This problem is further compounded when these individuals wish to attend social events or parties but lack the necessary connections or information to do so.

Various attempts have been made to address these issues. One common method is through word-of-mouth, where individuals ask their friends or acquaintances about others who might share their interests or about any upcoming social events. Another method involves the use of social media or messaging platforms to spread the word among their circle of friends.

However, these methods have their limitations. For one, they tend to only reach a limited number of people, typically those within the individual's immediate social circle. This can be restrictive, especially for those looking to expand their social network or explore new interests. Furthermore, these methods may not be the most efficient or timely. Information may not be disseminated quickly enough, or it may not reach the intended recipients at all. Lastly, these methods may not be the most convenient or aesthetically pleasing. The process of asking around or posting on social media can be cumbersome and time-consuming, and the resulting information may not be presented in a clear or appealing manner.

### SUMMARY

The invention is an application that enables users to create or view “hotspots,” which are gatherings of people with similar interests, events, gatherings, etc. A user can create a hotspot and label it according to their interest, such as “want to meet chess players.” This hotspot will then appear as a red dot on an interactive map, allowing other users to see it. If they are interested, they can click on it and go to the location.

The application also allows users to see available parties or functions in their area. The parties are updated in real time, so if a party is canceled, the user will know immediately, preventing them from going to a canceled event.

The application improves upon previous solutions by allowing users to create a hotspot for any interest they have, making it easier for them to meet new people with the same interest. It also makes it easier for users to find parties or functions in their area and see how many people are there, as well as view short clips of the party, if permitted by the host.

The application has several benefits. It allows users to write any description about the hotspot, such as the address, theme, interest, start time, and end time. Users can create their own hotspot, see how many people are in a hotspot, and view short clips or pictures of a specific hotspot, with the host's permission.

Users can also see future hotspots that will start soon, if the host decides to share this information. They can receive notifications about changes to certain hotspots, such as if a canceled party starts again. The application collects data about the success rate of any given area that has hosted parties. The host of a hotspot can livestream the party, and users can see in real time if the police are at a party, which will be displayed as a little blue and red siren lighting up on the hotspot on the map.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a network architecture for creating, organizing, and accessing purpose-driven social gatherings via a mobile application in accordance with an exemplary embodiment of the invention.

FIG. 2 illustrates a system architecture for creating, organizing, and accessing purpose-driven social gatherings via a mobile application in accordance with an exemplary embodiment of the present invention.

FIG. 3 illustrates an exemplary computer implemented process for creating, organizing, and accessing purpose-driven social gatherings via a mobile application according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In one embodiment, the present invention is a mobile application that facilitates the creation and discovery of social gatherings, referred to as “hotspots,” based on shared interests and locations. The app allows users to create hotspots by specifying a theme, description, and location, which are then displayed on an interactive map for other users to explore and join.

When a user creates a hotspot, such as a gathering for chess enthusiasts or a party, the app generates a visual representation of the event, typically in the form of a red dot, on the interactive map. Other users can browse the map, view the details of each hotspot, and choose to participate in those that align with their interests. The app provides a platform for like-minded individuals to connect, socialize, and engage in activities they enjoy.

The interactive map is a central feature of the app, serving as a real-time guide to ongoing and upcoming hotspots. As users create, modify, or cancel events, the map dynamically updates to reflect the latest information. This ensures that users have access to accurate and timely data when planning their social activities, reducing the risk of arriving at a canceled event or missing out on new opportunities.

To enhance the user experience, the app includes a comprehensive event description system. Hotspot creators can provide detailed information about their gatherings, such as the purpose, expected attendees, location specifics, and any special requirements or guidelines. This allows potential participants to make informed decisions about which hotspots to join and helps foster a sense of community and shared expectations among attendees.

In addition to user-created hotspots, the app may also integrate with external event databases or APIs to populate the map with a wider range of social activities. This could include public events, concerts, festivals, or other gatherings that may be of interest to users based on their preferences and location.

The app's user interface is designed to be intuitive and user-friendly, enabling users to easily navigate the map, filter hotspots based on their interests, and access detailed event information. Users can create personalized profiles, connect with friends, and communicate with other attendees through integrated messaging or chat features.

To ensure privacy and safety, the app may incorporate user authentication and permission controls. Users can choose to make their hotspots public or visible only to a selected group of friends or community members. The app may also include reporting and moderation tools to address any inappropriate content or behavior.

Overall, the present invention provides a convenient and efficient way for individuals to discover, create, and participate in social gatherings that align with their interests and location. By leveraging real-time updates and an interactive map, the app helps users stay informed about the latest events and fosters a vibrant community of like-minded individuals.

### Network Architecture

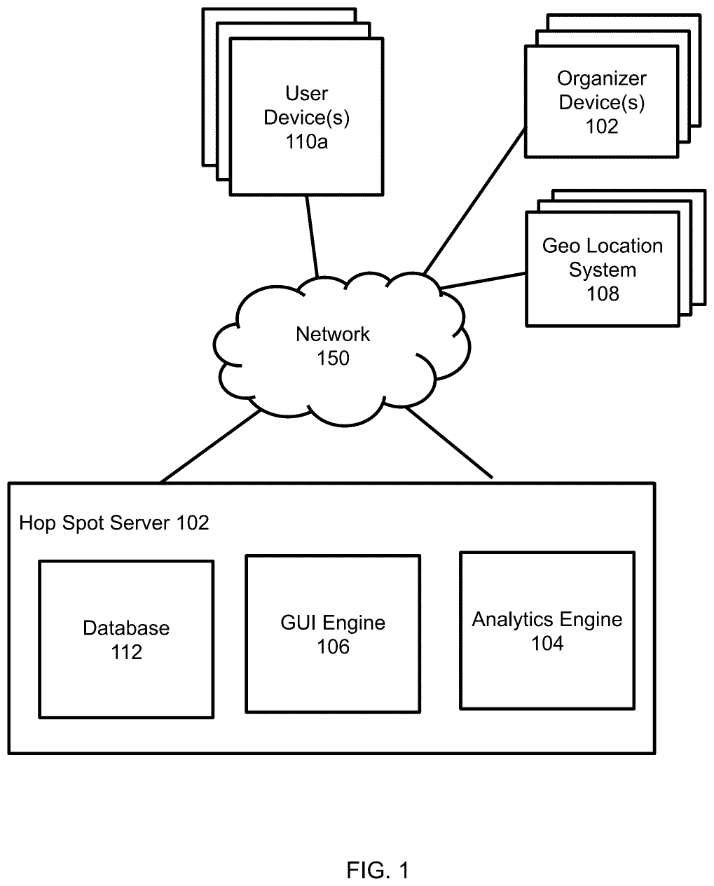

FIG. 1 illustrates an exemplary network architecture for creating, organizing, and accessing purpose-driven social gatherings via a mobile application according to one embodiment. FIG. 1 illustrates an exemplary embodiment of the hotspot system. It includes user devices 110a, organizer devices 110b, geo location system 108, network 150, hot spot server 102, which further comprises a database 112, GUI engine 106, and an analytics engine 104. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

In one embodiment, the Geo Location System 108 is a component of the mobile application that enables users to view and explore various social gatherings or “hotspots” within their chosen area or city, provided they grant the necessary permissions. The system utilizes the user's geographic location data to display nearby hotspots on an interactive map interface, represented by distinct visual markers such as red dots.

The Geo Location System 108 allows users to browse and discover a wide range of social gatherings based on their interests and preferences. For instance, if a user is interested in meeting fellow chess enthusiasts, they can search for or create a hotspot labeled “want to meet chess players.” This hotspot will then appear on the map, allowing other users with similar interests to identify and potentially join the gathering.

The system operates by continuously updating the map interface in real-time, ensuring that users have access to the most current information about available hotspots. When a new hotspot is created, it is instantly added to the map, while canceled or expired hotspots are promptly removed. This dynamic updating mechanism prevents users from inadvertently attempting to attend a gathering that is no longer active, saving them time and effort.

To function effectively, the Geo Location System 108 relies on various technologies and data sources. It may utilize GPS (Global Positioning System) or other location-based services to determine the user's current position and display relevant hotspots in their vicinity. Additionally, the system may integrate with mapping APIs (Application Programming Interfaces) to render the interactive map interface and provide features such as zooming, panning, and searching for specific locations.

Alternatives to the described implementation of the Geo Location System 108 exist, as would be apparent to a person of ordinary skill in the art, and may be used without departing from the scope of the invention. For example, instead of using GPS, the system could employ other location-tracking technologies like Wi-Fi positioning or cellular triangulation. The visual representation of hotspots on the map could also vary, using different colors, icons, or heat maps to indicate the popularity or density of gatherings in a particular area. Furthermore, the system could incorporate additional filters or search criteria, allowing users to refine their hotspot exploration based on factors such as date, time, or specific categories of interest.

In one embodiment, the Hot Spot Server 102 is a system that facilitates connection between users and provides real-time updates about various hotspots in a given area.

The primary function of the Hot Spot Server 102 is to enable users to connect with others and view different hotspots within their vicinity. The system provides live updates about these hotspots, such as changes in the number of attendees or the status of the event. For instance, if more people join a hotspot, making it larger, or if a hotspot gets canceled, the system updates this information in real time.

The Hot Spot Server 102 operates by maintaining a database of hotspots, which are created by users of the application. When a user creates a hotspot, the system registers it and displays it on an interactive map. The system constantly monitors the status of these hotspots, tracking changes such as the number of attendees or any changes in the event status. This information is then relayed to the users in real time, allowing them to make informed decisions about which hotspots to join.

There are alternative methods that can be used to achieve similar results. For instance, a peer-to-peer network could be used instead of a centralized server. In this setup, each user's device would communicate directly with other devices in the network to share information about hotspots. Another alternative could be the use of distributed ledger technology, such as blockchain, to maintain a decentralized, transparent, and tamper-proof record of hotspots and their statuses.

In one embodiment, the Database 112 serves as a centralized repository for storing and managing all the information collected and generated by the app. This system is responsible for securely storing, organizing, and retrieving data related to user profiles, hotspots, social gatherings, and other relevant information.

At a high level, the Database 112 acts as the backbone of the app, ensuring that data is persistently stored and readily accessible when needed. It maintains a structured collection of tables and relationships that represent the various entities and their associations within the app's ecosystem.

The Database 112 performs several crucial functions. It stores user account information, including personal details, preferences, and authentication credentials. It also maintains a comprehensive record of all the hotspots created by users, including their locations, descriptions, timestamps, and any associated metadata. Additionally, the database keeps track of user interactions, such as hotspot check-ins, ratings, and comments, enabling features like popularity tracking and user recommendations.

To ensure efficient and reliable data storage and retrieval, the Database 112 employs a suitable database management system (DBMS). This DBMS provides the necessary tools and interfaces for defining the database schema, performing data manipulation operations (e.g., inserting, updating, deleting records), and executing complex queries to retrieve specific subsets of data. The chosen DBMS may offer features such as indexing, transaction management, and data integrity constraints to optimize performance and maintain data consistency.

The Database 112 may be implemented using various database technologies, depending on the specific requirements of the app. One common approach is to use a relational database management system (RDBMS) like MySQL, PostgreSQL, or Microsoft SQL Server. These systems organize data into tables with predefined schemas and use structured query language (SQL) for data manipulation and retrieval. Alternatively, the app may opt for a NoSQL database solution, such as MongoDB or Cassandra, which offer more flexibility in handling unstructured or semi-structured data and can scale horizontally to accommodate large volumes of data.

To ensure data security and privacy, the Database 112 incorporates appropriate measures such as encryption, access controls, and regular backups. Sensitive user information, such as passwords, is typically hashed or encrypted before being stored in the database. Access to the database is restricted to authorized components of the app, and proper authentication and authorization mechanisms are implemented to prevent unauthorized access.

The Database 112 may be hosted on various infrastructure setups, depending on the app's scalability and performance requirements. It can be deployed on a single server, a distributed cluster of servers, or a cloud-based database service like Amazon RDS or Google Cloud SQL. The chosen deployment approach takes into account factors such as data volume, concurrent user access, and geographical distribution of users.

In one embodiment, the GUI Engine 106 is a system that visually represents hotspots on a map, with the size and color of each dot indicating specific characteristics of the hotspot.

The GUI Engine 106 displays each hotspot as a red dot on a map. The size of the dot corresponds to the number of people in the hotspot, with larger dots indicating more attendees. Hotspots that are scheduled to start soon are represented as lightly shaded, translucent red dots. The system also allows users to zoom in and out on the map, similar to a GPS interface.

The GUI Engine 106 works by retrieving data from the Event Data Store 206 and translating this data into a visual format. The number of attendees at each hotspot is used to determine the size of the corresponding dot on the map. The system also checks the start time of each hotspot and adjusts the color of the dot accordingly. The zoom function is controlled by user input, with pinch gestures typically used to zoom in and out.

There are alternative methods that could be used to achieve a similar function. For instance, instead of using dot size to represent the number of attendees, the system could use different colors or symbols. Another alternative could be the use of 3D mapping technology to provide a more immersive and detailed view of the hotspot locations.

In one embodiment, the Analytics Engine 104 is a central component of the system that collects, organizes, and processes various types of information related to each hotspot. This engine acts as a data hub, aggregating and structuring the information obtained by the app to provide meaningful insights and support decision-making processes.

The Analytics Engine 104 performs several key functions. It collects data from various sources, such as user inputs, social media feeds, and external APIs, to gather relevant information about each hotspot. This information may include details like the number of people planning to attend the event, the expected start time, and any other relevant data points. The engine then organizes this data into a structured format, making it easier to analyze and interpret.

To accomplish its tasks, the Analytics Engine 104 employs a combination of data processing techniques and algorithms. It may utilize natural language processing (NLP) to extract meaningful information from unstructured text data, such as social media posts or user comments. The engine may also leverage machine learning algorithms to identify patterns and trends in the collected data, enabling it to make predictions or generate insights about each hotspot.

The organized data is then stored in a database or other suitable data storage system, allowing for efficient retrieval and analysis. The Analytics Engine 104 may also interface with other components of the system, such as the user interface or notification modules, to present the processed information in a user-friendly manner or trigger relevant actions based on the insights generated.

Alternatives to the described Analytics Engine 104 may include using pre-built analytics platforms or services, such as Google Analytics or Mixpanel, to handle the data collection and processing tasks. These third-party solutions often provide a range of tools and features for analyzing and visualizing data, which can be integrated into the app's ecosystem.

Another alternative approach is to use a more decentralized architecture, where the data processing and analysis tasks are distributed across multiple components or microservices. This can help improve scalability and flexibility, as each component can be developed and maintained independently.

Additionally, the Analytics Engine 104 may incorporate other data processing techniques, such as rule-based systems or statistical analysis, depending on the specific requirements and complexity of the data being handled. The choice of techniques and algorithms will depend on factors such as the volume and variety of data, the desired level of insights, and the computational resources available.

User device(s) 110 and/or organizer device(s) 102 include, generally, a computer or computing device including functionality for communicating (e.g., remotely) over a network 150. User device(s) 110 and/or organizer device(s) 102 are herein used interchangeable. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### System Architecture

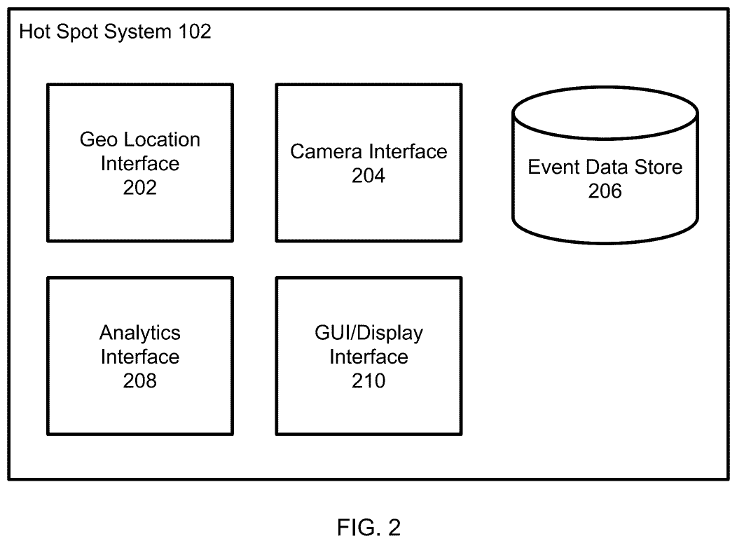

FIG. 2 illustrates an exemplary embodiment of the system for creating, organizing, and accessing purpose-driven social gatherings via a mobile application. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

In one embodiment, the Geo Location Interface 202 is a subsystem that enables the app to display the location of hotspots and other relevant information based on the user's current position. The Geo Location Interface 202 utilizes signals from satellites, such as those used in Global Positioning System (GPS), to determine the user's precise location. By processing these signals, the subsystem can accurately pinpoint the user's coordinates, which serve as the basis for displaying nearby hotspots and other location-specific data.

The Geo Location Interface 202 works by continuously receiving and analyzing signals from multiple satellites orbiting the Earth. These satellites transmit time-stamped signals that the subsystem captures using a built-in or external receiver. By measuring the time difference between when the signals were sent and when they were received, the subsystem can calculate the distance between the user's device and each satellite. Using trilateration techniques, which involve the intersection of spheres centered at each satellite's position, the Geo Location Interface 202 can determine the user's precise location on the Earth's surface.

Once the user's location has been determined, the Geo Location Interface 202 communicates this information to other components of the app, such as the mapping and data visualization modules. These components use the location data to retrieve and display relevant information, such as the positions of nearby hotspots, on a digital map. The app can also overlay additional location-specific data, such as the presence of public authorities at a particular hotspot, to provide users with a more comprehensive understanding of their surroundings.

In addition to GPS, the Geo Location Interface 202 can utilize alternative technologies for determining the user's location. These include: Wi-Fi Positioning System (WPS): By analyzing the signal strengths of nearby Wi-Fi access points and comparing them to a database of known access point locations, the subsystem can estimate the user's position. Cell Tower Triangulation: The subsystem can determine the user's approximate location by measuring the signal strengths and timing differences from multiple nearby cell towers. Assisted GPS (A-GPS): This technology combines GPS with cell tower triangulation to improve location accuracy and speed up the initial position fix, particularly in areas with poor satellite signal reception. Inertial Navigation Systems (INS): By using sensors such as accelerometers and gyroscopes, the subsystem can track the user's movements and estimate their position relative to a known starting point. The Geo Location Interface 202 may employ one or more of these alternative technologies in conjunction with, or as a fallback to, GPS, depending on factors such as signal availability, device capabilities, and desired accuracy. By leveraging multiple location determination methods, the subsystem can provide a more robust and reliable user experience across a variety of environments.

In one embodiment, the Camera Interface 204 is a subsystem that enables the host of a hotspot to share visual content, such as short clips or pictures, of the hotspot.

The Camera Interface 204 serves to provide potential attendees with a visual representation of the hotspot, giving them an idea of what the environment looks like and what activities are taking place. This allows users to make more informed decisions about whether they would like to join the hotspot.

The Camera Interface 204 works by integrating with the device's camera function. When the host decides to share visual content, they can use the Camera Interface 204 to capture and upload the content directly to the hotspot's information page. This content is then visible to all users who view the hotspot on their interactive map.

There are alternative methods that could be used to achieve a similar function. For instance, instead of integrating with the device's camera, the system could allow users to upload pre-existing photos or videos from their device's gallery. Another alternative could be the use of live streaming technology, allowing the host to broadcast real-time video footage of the hotspot. This would provide users with an even more accurate representation of the current state of the hotspot.

In one embodiment, the Event Data Store 206 is a subsystem designed to store data related to various events or hotspots.

The Event Data Store 206 collects and stores information such as the number of attendees, the geographical location of the event, and whether the event was cancelled prematurely. This data can be used for a variety of purposes, such as analyzing trends, improving event planning, or enhancing user experience.

The Event Data Store 206 operates by collecting data from each event or hotspot. This data is gathered through user interactions with the application, such as creating a hotspot, joining a hotspot, or leaving a hotspot. Once collected, the data is stored in a structured format, making it easy to retrieve and analyze when needed.

There are alternative methods that could be used for data storage. For instance, instead of a centralized data store, a distributed database could be used. This would involve storing data across multiple nodes, potentially improving data redundancy and reliability. Another alternative could be the use of cloud-based storage solutions, which could offer scalability and accessibility advantages.

In one embodiment, the Analytics Interface 208 is a subsystem that focuses on organizing and managing information related to user interactions and connections within the app. This subsystem plays a crucial role in facilitating social networking and enabling users to connect with each other based on shared interests, events, or locations.

At a high level, the Analytics Interface 208 collects, structures, and analyzes data pertaining to user interactions, such as friend requests, message exchanges, and shared content. It also keeps track of user profiles, preferences, and activities to provide personalized recommendations and enhance the overall user experience.

The Analytics Interface 208 works by continuously monitoring and capturing user interactions within the app. When users perform actions such as sending friend requests, joining groups, or engaging in conversations, the subsystem records these events along with relevant metadata, such as timestamps, user identifiers, and context information. The collected data is then processed and stored in a structured format, typically using databases or other suitable data storage systems.

To make sense of the collected data, the Analytics Interface 208 employs various data analysis techniques and algorithms. These may include social network analysis algorithms to identify patterns and relationships between users, sentiment analysis to gauge user opinions and emotions, and collaborative filtering techniques to generate personalized recommendations based on user similarities.

The subsystem may also leverage machine learning models to predict user behavior, such as the likelihood of two users connecting or the potential for a user to attend a particular event. These predictions can be used to provide proactive suggestions, enhance event recommendations, or optimize the user interface to encourage user engagement and interaction.

The Analytics Interface 208 may also integrate with other components of the app, such as the user interface and notification modules, to deliver real-time updates and personalized content to users. For example, it may trigger notifications when a user receives a new friend request or suggest relevant events based on the user's connections and interests.

Alternatives to the described Analytics Interface 208 may include using third-party social networking APIs or services, such as Facebook Graph API or Twitter API, to leverage their existing infrastructure and data analysis capabilities. These platforms often provide robust tools for managing user connections, analyzing social graphs, and generating insights based on user interactions.

Another alternative approach is to use a decentralized architecture, where user data is stored and processed on individual user devices rather than a centralized server. This can help address privacy concerns and give users more control over their personal information. In such cases, the Analytics Interface 208 would need to be adapted to work with a distributed data model and employ privacy-preserving techniques, such as secure multi-party computation or homomorphic encryption, to perform analysis on encrypted data.

Additionally, the Analytics Interface 208 may incorporate other data analysis techniques, such as graph databases or natural language processing, depending on the specific requirements and complexity of the user interaction data being handled. The choice of techniques and algorithms will depend on factors such as the scale of the user base, the desired level of personalization, and the available computational resources.

In one embodiment, the subsystem GUI/Display Interface 210 serves as the primary user interface for displaying hotspots, along with detailed descriptions, addresses, and other relevant information about each hotspot.

The GUI/Display Interface 210 functions by presenting a user-friendly graphical interface that maps out all available hotspots. Users can interact with this map to explore different hotspots. Upon selecting a hotspot, the interface provides a detailed view that includes the hotspot's description, address, and other pertinent details such as the event's start and end times, the interests it caters to, and any specific instructions or notes from the host.

The operation of GUI/Display Interface 210 involves retrieving data from the Event Data Store 206, which contains all the information about the hotspots. This data is then processed and formatted for display. The interface updates in real-time to reflect changes in hotspot data, ensuring users have access to the most current information.

Alternatives to the GUI/Display Interface 210 could include a text-based interface for users who prefer or require screen readers or other accessibility tools. Another alternative could be the use of augmented reality (AR) technology to overlay hotspot information onto a live view of the user's surroundings through their device's camera. Additionally, a voice-activated interface could allow users to inquire about hotspots and receive spoken responses, providing an alternative for hands-free use or enhancing accessibility for users with visual impairments.

### Computer Implemented Process

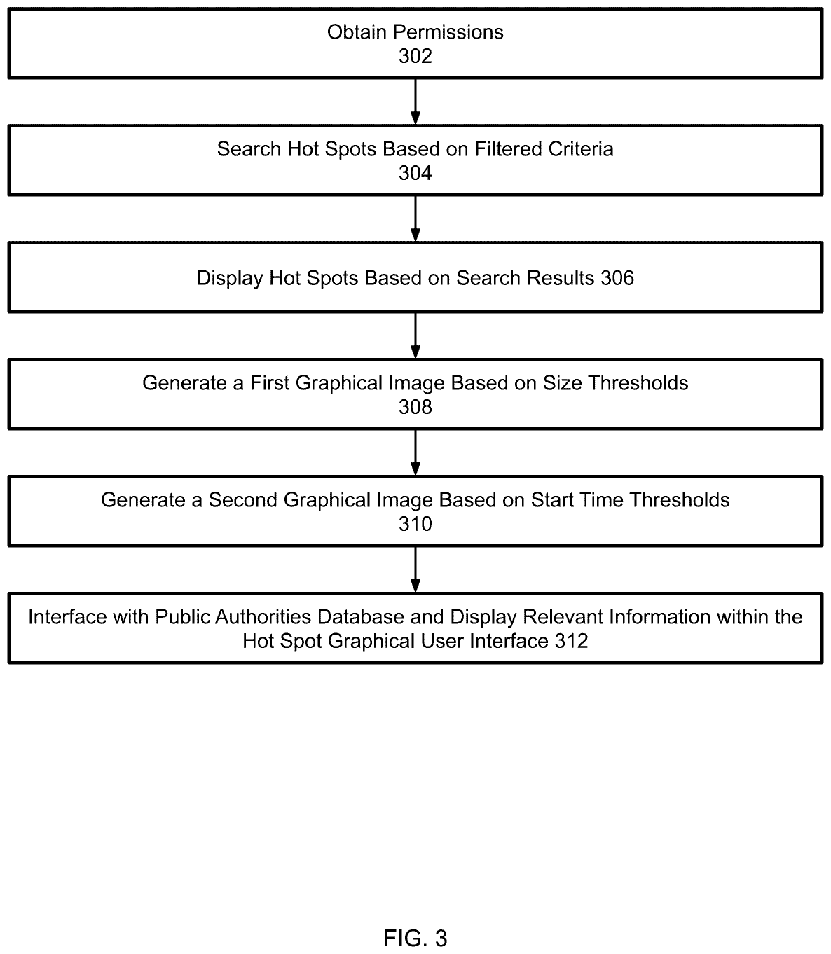

FIG. 3 illustrates an exemplary process for identifying and displaying hot-spots. The process steps described herein may be performed in association with a system such as that described in FIG. 1 and/or FIG. 2 above or in association with a different system. The process may comprise additional steps, fewer steps, and/or a different order of steps without departing from the scope of the invention as would be apparent to one of ordinary skill in the art.

In one embodiment, the software process 302 involves obtaining the necessary permissions from the user to enable the app's functionality and create a personalized user experience. This process is initiated when the user launches the app for the first time or when certain features are accessed that require specific permissions.

The primary permission requested by the app is access to the user's location data while the app is in use. This permission allows the app to determine the user's current geographic position, which is essential for displaying relevant hotspots and social gatherings in their vicinity. By granting location permission, the user enables the app to provide tailored recommendations and enhance their overall experience.

In addition to location permission, the software process 302 prompts the user to create an account within the app. The account creation process typically involves collecting basic user information such as name, email address, and optionally, additional profile details. Creating an account enables the user to personalize their preferences, save favorite hotspots, and interact with other users if desired.

The software process 302 handles the permission requests and account creation flow in a user-friendly manner. When the app is launched, it displays a clear and concise prompt explaining the need for location permission and its benefits. The user is given the option to grant or deny this permission. If the permission is granted, the app proceeds to request the user to create an account. The account creation process is streamlined, requiring minimal input from the user to minimize friction and encourage completion.

Throughout the permission and account creation process, the app adheres to best practices in user privacy and data security. It provides transparent information about how the user's location data will be used and stored, and offers options for the user to control their privacy settings. The app securely transmits and stores user account information, implementing appropriate encryption and data protection measures.

Alternatives to the described software process 302 exist. Instead of requesting location permission upon app launch, the app could defer this request until the user attempts to access a feature that specifically requires location data. This approach allows users to explore other aspects of the app before deciding whether to grant location permission. Additionally, the app could offer alternative sign-in methods, such as the ability to create an account using existing social media profiles or third-party authentication services, streamlining the account creation process for users who prefer those options.

In one embodiment, the software process, Search Hot Spots Based on Filtered Criteria 304, is a feature that allows users to search for specific types of hotspots based on their preferences or interests.

The Search Hot Spots Based on Filtered Criteria 304 allows users to find hotspots that align with their interests, whether that be a party or a gathering to play chess. This feature helps users to narrow down their search and find relevant hotspots more efficiently.

The software process works by allowing users to input specific criteria into a search bar or select from predefined categories. The system then scans the database of hotspots, filtering out those that do not match the user's criteria. The remaining hotspots, which align with the user's search, are then displayed on the interactive map.

There are alternative methods that could be used to achieve a similar function. For instance, instead of a search bar, the system could use a voice recognition feature, allowing users to verbally state their preferences. Another alternative could be the use of artificial intelligence to predict user preferences based on their past behavior, thereby automatically filtering hotspots without the user having to input specific criteria.

In one embodiment, the software process, Display Hot Spots Based on Search Results 306, is a feature that visually presents hotspots on a map based on user-defined search results.

The Display Hot Spots Based on Search Results 306 function serves to visually represent the location of hotspots that match a user's search criteria or, alternatively, all available hotspots within a user's area or city. This provides users with a geographical context for each hotspot, aiding in their decision-making process.

The software process works by taking the results of a user's search and plotting the corresponding hotspots as red dots on an interactive map. The map can be zoomed and panned, allowing users to view hotspots in their immediate vicinity or in a broader area, such as their entire city.

There are alternative methods that could be used to achieve a similar function. For instance, instead of displaying hotspots as red dots on a map, the system could use different symbols or colors to represent different types of hotspots. Another alternative could be the use of augmented reality technology to overlay hotspot locations onto a live view of the user's surroundings, providing a more immersive user experience.

In one embodiment, the software process, Generate a First Graphical Image Based on Size Thresholds 308, dynamically adjusts the visual representation of hotspots on a map according to the number of participants present.

This software process functions by increasing or decreasing the size of a hotspot's graphical representation, depicted as a red dot on a map, contingent upon the current attendee count. When the number of people in a hotspot rises, the red dot correspondingly enlarges. Conversely, should the attendee count decrease, the size of the dot diminishes.

The operation of Generate a First Graphical Image Based on Size Thresholds 308 involves real-time data collection regarding the number of attendees at each hotspot. This data is then compared against predefined size thresholds. Depending on which threshold the current attendee count falls into, the system generates a graphical image of the hotspot with an appropriately sized red dot. This image is then rendered on the user interface, providing an intuitive visual cue to users regarding the popularity of each hotspot.

Alternatives to this approach could include using different shapes or colors to represent varying levels of attendance, rather than adjusting the size of a single graphical element. Another alternative could involve the use of animations, where the graphical representation pulsates or changes intensity in response to changes in attendance, providing a more dynamic visual indicator. Additionally, a layered approach could be employed, overlaying additional information or icons on the hotspot representation to indicate not just attendance levels, but also the nature of the activity or event taking place.

In one embodiment, the software process, Generate a Second Graphical Image Based on Start Time Thresholds 310, visually differentiates hotspots on a map based on their scheduled start times.

This software process is designed to help users quickly identify which hotspots are about to commence. It does this by altering the color intensity of the hotspot's graphical representation on the map. Specifically, hotspots that are scheduled to start shortly are displayed as red dots that are slightly lighter in color than those representing hotspots already in progress or scheduled to start at a later time.

The operation of Generate a Second Graphical Image Based on Start Time Thresholds 310 involves checking the scheduled start time of each hotspot against the current time. Based on how soon the hotspot is set to begin, the system adjusts the color of the hotspot's graphical representation. This lighter shade of red serves as a visual cue to users that the hotspot is about to start, enabling them to make timely decisions about which events to attend.

Alternatives to this approach could include using different visual indicators, such as changing the shape of the hotspot icon for those about to start, or adding a visual effect like a blinking or pulsating animation. Another alternative could involve overlaying a countdown timer on the hotspot icon, providing users with a more precise indication of how soon the event will begin. Additionally, incorporating textual labels or tags that explicitly state the remaining time until start could offer a direct and informative alternative to color-based differentiation.

In one embodiment, the software process, Interface with Public Authorities Database and Display Relevant Information within the Hot Spot Graphical User Interface 312, enhances user awareness by providing real-time updates on the presence of public authorities, such as police, at hotspots.

This software process functions by establishing a connection with databases maintained by public authorities to retrieve real-time data regarding their presence at various locations. Once this information is obtained, the system integrates it into the Hot Spot Graphical User Interface, displaying icons or indicators on the map where public authorities are currently present. This allows users to make informed decisions about attending or staying at a particular hotspot.

The operation of Interface with Public Authorities Database and Display Relevant Information within the Hot Spot Graphical User Interface 312 involves querying the public authorities' database at regular intervals or upon user request. The system then parses this data to identify relevant information about the presence of public authorities at hotspots. This information is visually represented on the user interface, such as by displaying a small blue and red siren icon on the hotspot's graphical representation on the map.

Alternatives to this approach could include using push notifications to alert users when public authorities are detected near a hotspot they are interested in or currently attending. Another alternative could be the integration of a user-reporting feature, allowing attendees to manually report the presence of public authorities, which, after verification, could be displayed to other users. Additionally, leveraging social media feeds or other public reporting platforms as sources of information about the presence of public authorities could offer a broader, albeit potentially less precise, data set for informing users.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

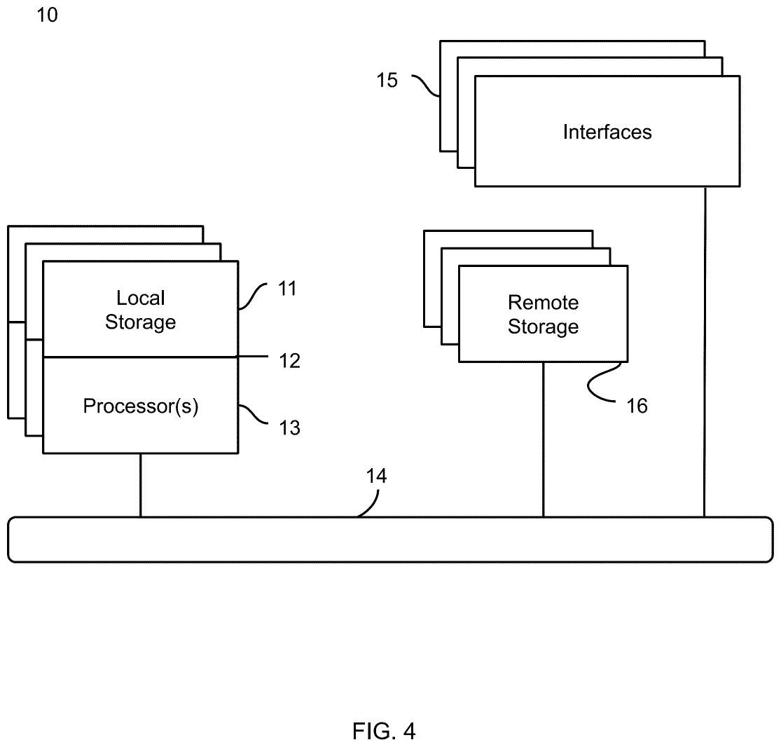

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

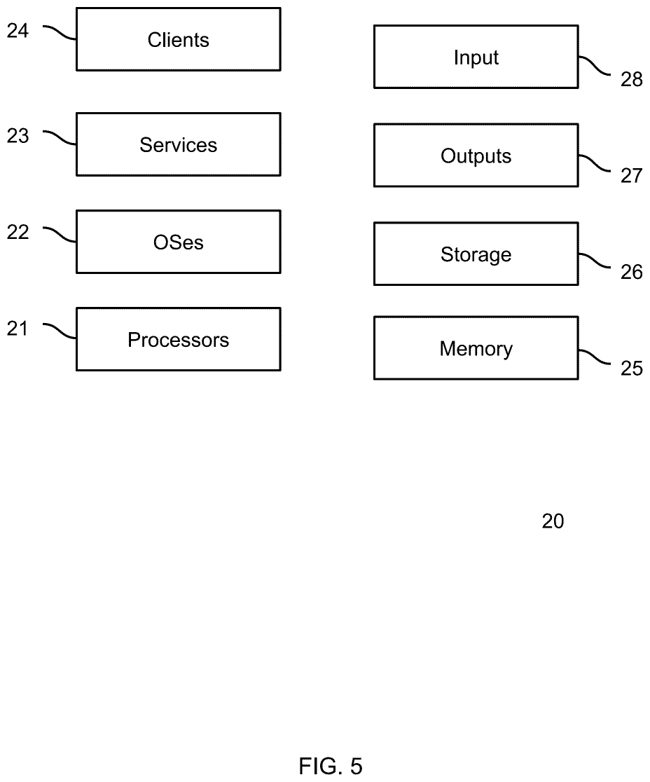

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

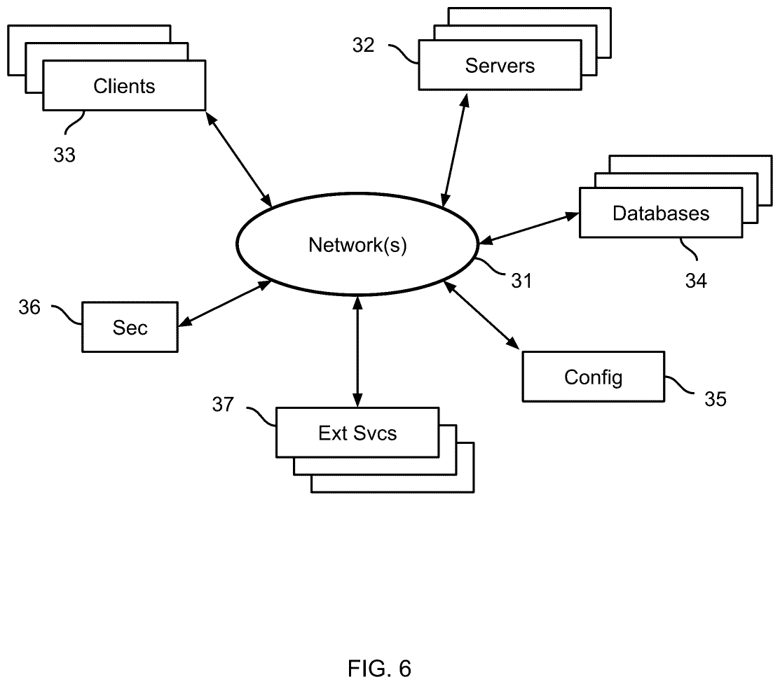

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

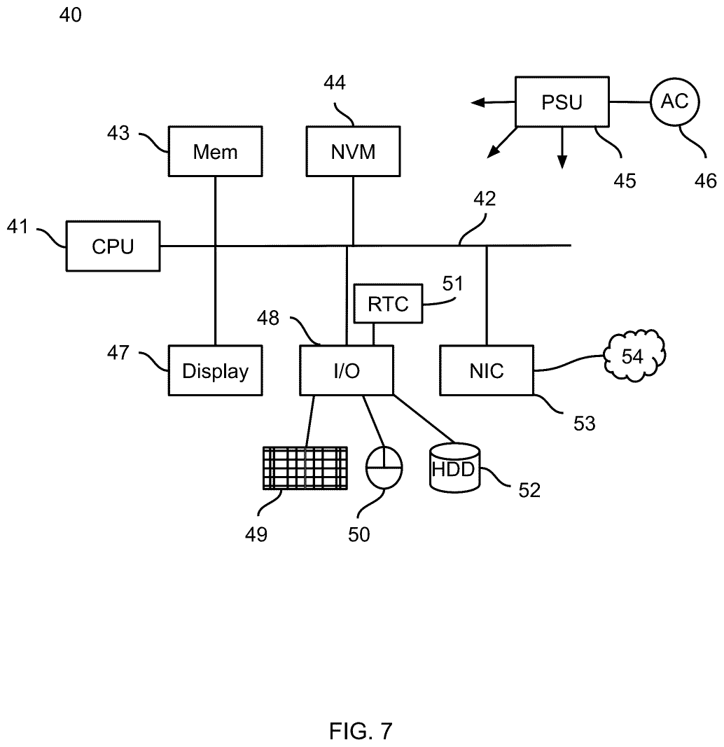

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A method for identifying and displaying social gatherings, comprising:
obtaining, by a mobile application, permission to use a user's location;
searching for hotspots based on user-specified filtered criteria;
displaying the hotspots on an interactive map as graphical representations;
generating a first graphical image for each hotspot based on size thresholds, wherein the size of the graphical representation increases as the number of people in the hotspot increases;
generating a second graphical image for each hotspot based on start time thresholds, wherein the color of the graphical representation is lighter if the hotspot is set to begin shortly; and
interfacing with a public authorities database and displaying relevant information within the hotspot graphical user interface, indicating the presence of public authorities at the hotspot.

2. The method of claim 1, wherein the hotspots represent social gatherings of people with similar interests.

3. The method of claim 1, wherein the user-specified filtered criteria include a type of social gathering or activity.

4. The method of claim 1, wherein the interactive map dynamically updates in real-time to reflect changes in the hotspots.

5. The method of claim 1, further comprising:
allowing users to create new hotspots by specifying a theme, description, and location.

6. The method of claim 5, wherein the created hotspots are displayed on the interactive map for other users to explore and join.

7. The method of claim 1, further comprising:
providing a comprehensive event description system for each hotspot, including information about the purpose, expected attendees, location specifics, and special requirements or guidelines.

8. The method of claim 1, further comprising:
integrating with external event databases or APIs to populate the interactive map with additional social activities.

9. The method of claim 1, further comprising:
enabling users to create personalized profiles, connect with friends, and communicate with other attendees through integrated messaging or chat features.

10. The method of claim 1, further comprising:
incorporating user authentication and permission controls, allowing users to choose the visibility of their created hotspots.

11. A system for identifying and displaying social gatherings, comprising:
a mobile application configured to:
obtain permission to use a user's location;
search for hotspots based on user-specified filtered criteria;
display the hotspots on an interactive map as graphical representations;
generate a first graphical image for each hotspot based on size thresholds, wherein the size of the graphical representation increases as the number of people in the hotspot increases;
generate a second graphical image for each hotspot based on start time thresholds, wherein the color of the graphical representation is lighter if the hotspot is set to begin shortly; and
interface with a public authorities database and display relevant information within the hotspot graphical user interface, indicating the presence of public authorities at the hotspot.

12. The system of claim 11, wherein the hotspots represent social gatherings of people with similar interests.

13. The system of claim 11, wherein the user-specified filtered criteria include a type of social gathering or activity.

14. The system of claim 11, wherein the interactive map dynamically updates in real-time to reflect changes in the hotspots.

15. The system of claim 11, wherein the mobile application is further configured to:
allow users to create new hotspots by specifying a theme, description, and location.
